(19) United States
(12) Patent Application Publication
(10) Pub. No.: US 2024/0201514 A1
(43) Pub. Date: Jun. 20, 2024

(54) EYEWEAR WITH DETACHABLE TEMPLES HAVING STORAGE COMPARTMENT

(71) Applicant: Jack D. Zemer, San Diego, CA (US)

(72) Inventor: Jack D. Zemer, San Diego, CA (US)

(21) Appl. No.: 18/529,642

(22) Filed: Dec. 5, 2023

Related U.S. Application Data
(60) Provisional application No. 63/433,605, filed on Dec. 19, 2022.

(51) Int. Cl. G02C 5/14

(52) U.S. Cl. CPC G02C 5/14; G02C 2200/02

(57) ABSTRACT

A frame of eyewear in which temples can be detachably coupled to the front frame and the temples include storage compartments for storing small articles. The temples can magnetically couple to bridges at the hinge joints of the front frame so that the temples can be quickly and easily detached and reattached. Temples include storage space, and the magnets provide for sealing the storage space as well as allows access to the storage space easily and quickly.

### CROSS-REFERENCE TO RELATED APPLICATIONS

This application claims priority from a U.S. provisional patent application Ser. No. 63/433,605, filed on Dec. 19, 2022, which is incorporated herein by reference in its entirety.

### FIELD OF INVENTION

The present invention relates to eyewear, and more particularly, the present invention relates to eyewear with magnetic detachable and interchangeable temples, the temples have a storage compartment.

### BACKGROUND

Eyewear, such as sunglasses and eyeglasses are used for a variety of purposes. Eyeglasses are used to correct eyesight or limit exposure to harmful light levels. Sunglasses are quite popular to protect against harmful radiation from the sun, such as UV radiation. Besides the above uses, eyewear is also used for aesthetic purposes.

People often have two or more pairs of eyewear that just differ in design and are used interchangeably for aesthetic purposes. However, maintaining multiple pairs of eyewear is laborious and costly.

Also, storage containers are an essential part of life. People used storage containers for day-to-day tasks. Different types of storage containers are needed for different purposes. Specialized containers are used for certain specific purposes, such as storing precious items, secret storage spaces, and the like. A need is always there for a novel and specialized storage spaces.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directly to an eyewear in which temples are magnetically coupled to the frame front.

Another object of the present invention is that eyewear allows interchangeable temples or interchangeable frame fronts.

Another object of the present invention is that temples can be quickly interchanged.

Still, another object of the present invention is that sunglasses and eyeglasses can have common temples.

Yet another object of the present invention is that the need for multiple eyewear can be avoided.

A further object of the present invention is that eyewear is user-friendly.

Still, a further object of the present invention is that detaching temples avoids requiring excessive force or complicated mechanisms.

Yet a further object of the present invention is that magnetic attachments help reduce wear and tear, damage, or loosening over time.

An additional object of the present invention is that eyewear offers a convenient, reliable, and efficient attachment solution.

Yet an additional object of the present invention is that the eyewear provides specialized storage space.

In one aspect, disclosed is an eyewear that includes magnetically attachable temples. The temples include storage compartments, which is a critical feature of the present invention. The temples are hollow from the inside which forms an elongated storage space. The storage space can be used for storing small articles, such as a piece of rolled paper, cigarettes, pills, and the like, diamonds and small precious items, and the like small items. The storage compartment provides a safe storage space. Moreover, the storage compartments in the temples may also act as a hidden or secure storage space. The magnetic fasteners are specially designed to sealably close the storage space. This may ensure that moisture and dust may not enter the storage space. Magnetic temples may allow the temples to be quickly attached and detached, thus allowing the storage space to be quickly accessed. Also, it is to be understood that the size of storage compartments can be varied by changing the size of temples. Thus, the temples and the magnetic fasteners are crucial parts of the disclosed invention. The magnetic fasteners provide for a secure and convenient attachment method for the temples and at the same time provide for sealable closing of the temples. The magnetic fasteners ensure strong and reliable hold while maintaining comfort and functionality for the users. The magnetic fasteners can circumferentially surround the opening of the hollow storage compartment in the temple, so as to sealably secure the same. Magnetic fasteners may allow coupling the temples to the hinge joint on the front frame of the eyewear.

### BRIEF DESCRIPTION OF DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a perspective view of eyewear, according to an exemplary embodiment of the present invention.

FIG. 2 shows a temple detached from the front frame of the eyewear, a storage compartment in the temple, and a magnetic fastener for attaching the temple to the frame front, according to an exemplary embodiment of the present invention.

FIG. 3 is an exploded view of the eyewear, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting to embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

Disclosed is eyewear with detachable temples, wherein the temples include a storage compartment. The eyewear includes a frame and two lenses fitted in the frame. The frame includes a front frame and two temples coupled to the left and right bridges of the front frame. The temples can be magnetically coupled to the bridges so that they can be quickly attached and detached from the front frame. The temples can be coupled to the hinge joints on the bridges. This allows the temples of different designs to be used interchangeably. Moreover, front frames of different designs or types can be used interchangeably with the same set of temples. For example, the front frames with different lens types can be interchangeably used with a common pair of temples. The eyewear according to the present invention is durable and, wear and tear with conventional eyewear can be avoided. The temples can be detached easily and quickly for storage. The same can be attached quickly through the disclosed magnetic coupling. Any shock to the eyewear, such as a jerk to the temple may just result in the detaching of the temple without any damage to the eyewear. Thus, accidental damage can be largely reduced. The temples are hollow providing a storage compartment that can be used for storing small items. The storage compartment is a crucial feature of the present invention in that it provides a safe storage spaces for items, such as diamonds, cigarettes, and the like. The magnetic fasteners provide for sealably closing the storage compartment preventing any ingress of air, moisture, or dust.

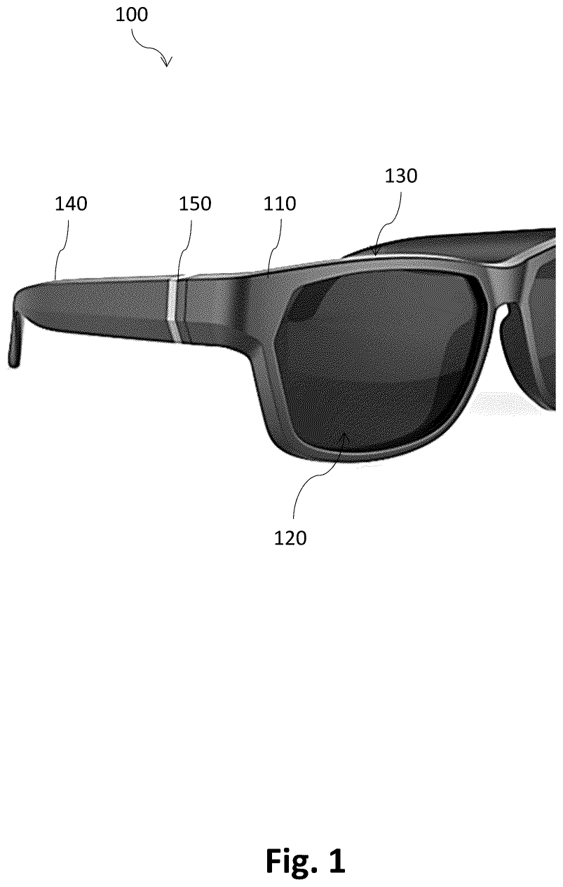

Referring to FIG. 1 which shows a perspective view of the disclosed eyewear. The eyewear includes a frame 110 and lenses 120 which are fitted into the frame. The frame includes a front frame 130 and a pair of temples 140 coupled to the front frame. The left and right portions of the front frame include bridges, referred to herein as the left and right bridges of the front frame. The bridges are curved rearwards, and the left and right temples are respectively coupled to the left and right bridges. As shown in the drawing, a magnetic fastener 150 magnetically couples the temples to the bridges of the front frame, such as through the hinge joints attached to the bridges.

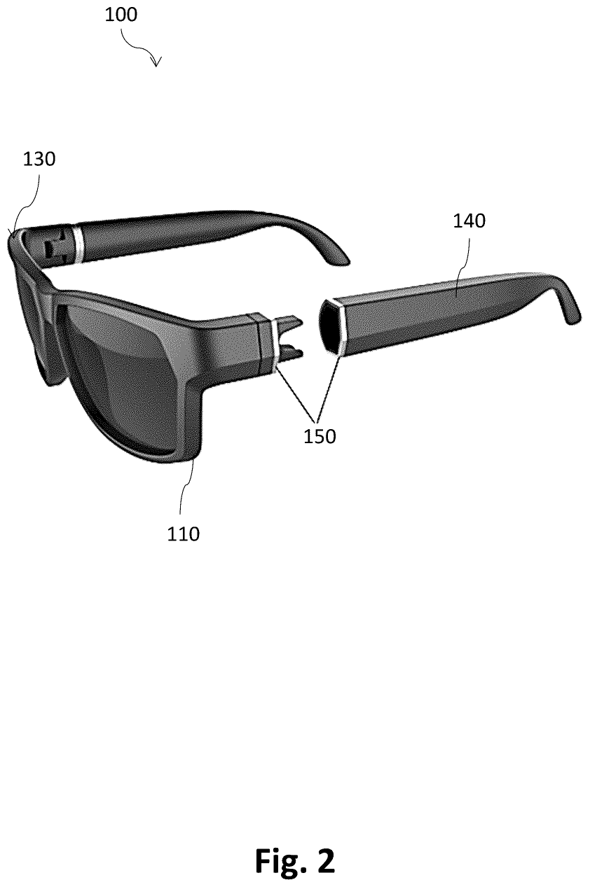

FIG. 2 shows one of the two temples detached from the front frame. Some force can be applied to pull apart the temple from the front frame. To attach the temple, the temple can be aligned and positioned over the respective bridge, and the magnetic force can pull and retain the temple, attaching the temple to the front frame.

As shown in FIG. 2, the temple is hollow, and this hollow space can be used for storage. Thin and long items can be stored within the temple. For example, the temple can act as a secret storage space. It is understood that this storage space is a crucial part of the invention. Moreover, the size and shape of the storage space and that of the temple can be varied without departing from the scope of the present invention. The magnetic fasteners for attaching the temples to the front frame can provide for sealing the storage compartment. The magnets allow for accessing the storage space quickly and easily. Also, it is to be understood that the functionality of the hinge joint may not be affected by the magnets. Also, the length of the storage compartment can extend up to the curved portion of the temple. The temple is linear along the majority of its length and then an end portion of the temple is curved. The storage compartment can extend along the liner portion up to the point wherein the temple starts to curve.

Each magnetic fastener has a bridge member and a temple member, wherein the bridge member of the magnetic fastener can magnetically couple to the temple member of the magnetic fastener. Both the bridge member and the temple member can be of the same size and shape; thus, one can juxtapose over other. As shown in FIG. 2, the bridge member and the temple member are hollow and polygonal in shape. Such a configuration of the bridge member and the temple member may be a critical feature of the invention allowing strong magnetic bonds. Although the drawing shows magnetic fasteners of a polygonal shape, it is understood that the shape can vary without departing from the scope of the present invention. For example, circular magnetic fasteners are within the scope of the present invention.

As shown in FIG. 1, a skirt extends from a hollow end of the temple; the skirt is thinner than the wall of the temple, so a step is formed between the outer surfaces of the skirt and the temple. The temple member of the magnetic fastener can be fitted over this skirt and the step, and may or may not appear continuous or coplanar with the wall of the temple. For example, the temple member may appear depressed, continuous, or protruding relative to the outer surface of the temple. The temple member can circumferentially surround the opening in the temple, ensuring that the opening is sealably closed.

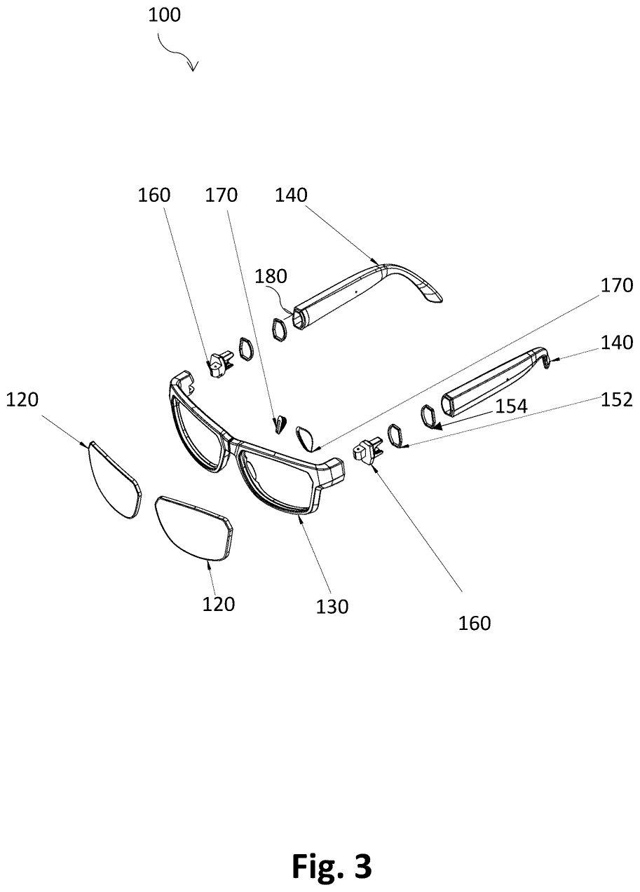

Also, referring to FIG. 3 which is an exploded view, the bridge member of the magnetic fastener can be coupled to a hinge joint 160 and this hinge joint can be coupled to the bridge of the front frame. The hinge joint may provide for a certain degree of pivotal movement of the temples relative to the front frame. For example, to keep the temples tightened against the head of the wearer. However, the hinge joints may be optional, and the bridge member of the magnetic fastener may be directly coupled to the bridge.

FIG. 3 shows eye frame 110, lenses 120, a pair of temples 130, a hinge joint 160, nose pads 170, bridge member 152, temple member 154 of the magnetic fasteners 150, and storage compartment 180.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A frame of eyewear with a storage compartment configured in one or both temples of the frame, the frame comprises:
a front frame comprising a left bridge and a right bridge;
a left temple and a right temple, each of the left temple and the right temple has a proximal end and a distal end;
a left magnetic fastener for coupling the proximal end of the left temple to the left bridge; and
a right magnetic fastener for coupling the proximal end of the right temple to the right bridge.

2. The frame according to claim 1, wherein each of the left magnetic fastener and the right magnetic fastener comprises a bridge member and a temple member, the bridge member and the temple member are configured to magnetic couple with each other, wherein the temple member is coupled to the proximal end of the respective temple, and the bridge member is coupled to the respective bridge.

3. The frame according to claim 1, wherein each of the left temple and the right temple is hollow providing storage compartments.

4. The frame according to claim 3, wherein each of the left temple and the right temple comprises a linear portion and a curved portion, the storage compartments extend along the respective liner portion up to a point wherein the temple starts to curve.

5. An eyewear comprising a frame and a pair of lenses, the frame has storage compartments in one or both temples of the frame, wherein the frame comprises:
a front frame comprising a left bridge and a right bridge;
a left temple and a right temple, each of the left temple and the right temple has a proximal end and a distal end;
a left magnetic fastener for coupling the proximal end of the left temple to the left bridge; and
a right magnetic fastener for coupling the proximal end of the right temple to the right bridge.

6. The eyewear according to claim 5, wherein each of the left magnetic fastener and the right magnetic fastener comprises a bridge member and a temple member, the bridge member and the temple member are configured to magnetic couple with each other, wherein the temple member is coupled to the proximal end of the respective temple, and the bridge member is coupled to the respective bridge.

7. The eyewear according to claim 5, wherein each of the left temple and the right temple is hollow providing the storage compartments.

8. A method for storing small articles in an eyewear, wherein the method comprises:
providing the eye frame comprising:
the front frame comprising a left bridge and a right bridge,
a left temple and a right temple, each of the left temple and the right temple has a proximal end and a distal end,
a left magnetic fastener for coupling the proximal end of the left temple to the left bridge, and
a right magnetic fastener for coupling the proximal end of the right temple to the right bridge,
detaching the left temple from the front frame;
detaching the right temple from the front frame; and
attaching the left temple and the right temple to the front frame.

9. The method according to claim 8, wherein each of the left magnetic fastener and the right magnetic fastener comprises a bridge member and a temple member, the bridge member and the temple member are configured to magnetic couple with each other, wherein the temple member is coupled to the proximal end of the respective temple, and the bridge member is coupled to the respective bridge.

10. The method according to claim 9, wherein each of the left temple and the right temple is hollow providing the storage compartment for storing the small articles.
